(19) United States
(12) Patent Application Publication
(10) Pub. No.: US 2025/0027764 A1
(43) Pub. Date: Jan. 23, 2025

(54) INFEROMETRIC MEASURING APPARATUS

(71) Applicant: Carl Zeiss SMT GmbH, Oberkochen (DE)

(72) Inventor: Steffen SIEGLER, Neresheim (DE)

(21) Appl. No.: 18/778,483

(22) Filed: Jul. 19, 2024

(30) Foreign Application Priority Data
Jul. 20, 2023 (DE) 102023206874.5

(51) Int. Cl. G01B 11/24; G01B 9/02; G01B 9/02015

(52) U.S. Cl. CPC G01B 11/2441; G01B 9/02027; G01B 9/02039; G01B 9/02085

(57) ABSTRACT

A measuring apparatus (10; 110; 210; 310; 410; 510; 610; 710) for interferometric determination of a property (50; 52) of a shape (50) of a test surface (12) of an object under test (14) comprises an irradiation device (22) for generating an input wave (24), a splitting module (18; 118; 318; 418; 518) configured to generate, from the input wave, two plane waves (32, 34) with parallel directions of propagation and with an offset from one another across the directions of propagation, a wavefront adaptation module (20; 720) for generating two measurement waves (44, 46) by adapting the respective wavefront of the plane waves with an offset from one another to a target shape of the optical test surface, and a detector (56) for capturing at least one interferogram (64) generated by superposition of the measurement waves (44r, 46r) following their interaction with the test surface.

### CROSS-REFERENCE TO RELATED APPLICATIONS

This application claims priority to the German Patent Application No. 10 2023 206 874.5 filed on Jul. 20, 2023, the entire disclosure of which is incorporated into the present application by reference.

### FIELD

The techniques disclosed herein relate to a measuring device and a method for interferometric determination of a property of a shape of a test surface of an object under test. For example, an optical element for microlithography can be measured as the object under test. In particular, the shape property determined can be the shape of the test surface itself. As a result of the need for ever smaller structures, ever higher demands are placed on the optical properties of optical elements used in microlithography. The optical surface shape of these optical elements must therefore be determined with the highest possible accuracy.

### BACKGROUND

Interferometric measuring apparatuses and methods in which a diffractive optical element generates a test wave and a reference wave from an input wave are known for the highly accurate interferometric measurement of optical surfaces down to the subnanometer range. The diffractive optical element can be used to adapt the wavefront of the test wave to a target surface of the object under test, in such a way that it would be incident perpendicularly on the target shape at every location and would be reflected back on itself. Deviations from the target shape can then be determined with the aid of the interferogram formed by the superposition of the reflected test wave and the reference wave.

For example, WO 2016/188620 A2 describes a measuring apparatus with a complex encoded computer-generated hologram (CGH) as a diffractive optical element. From an input wave, the CGH generates a test wave with a wavefront at least partly adapted to a target shape of the test surface directed at the test surface to be measured and a reference wave. The reference wave is reflected back to the CGH by a reflective optical element. Additional reference is made to DE 10 2011 004 376 B3.

A problem of such known measuring apparatuses is that measurement errors can occur, for example on account of air schlieren or grating structure defects in the CGH. The measuring apparatus can be operated in a high vacuum in order to minimize measurement errors that can be traced back to air schlieren. Calibration methods can be used to avoid measurement errors that can be traced back to grating structure defects. However, all these measures increase the outlay required for the interferometric measurement or the complexity of the measuring apparatus.

### SUMMARY

It is an object of the techniques disclosed herein to provide a measuring apparatus and a method with which the aforementioned problems may be solved and, in particular, a property of a shape of a test surface can be determined with very high accuracy and reasonable outlay.

According to the disclosed techniques, the aforementioned object can be achieved by, for example, a measuring apparatus for interferometric determination of a property of a shape of a test surface of an object under test. The measuring apparatus comprises an irradiation device or source for generating an input wave and a splitting module, also referred to herein as a wave splitter, configured to generate, from the input wave, two plane waves with parallel directions of propagation and with an offset from one another across the directions of propagation. Further, the measuring apparatus comprises a wavefront adaptation module, i.e., a wavefront adaptor, configured to generate two measurement waves by adapting the respective wavefront of the plane waves with an offset from one another to a target shape of the optical test surface and a detector for capturing at least one interferogram generated by superposition of the measurement waves following their interaction with the test surface.

For example, the property of the shape of the test surface determined by the measuring apparatus can be a derivative of the test surface shape, the configuration of the test surface shape, or the shape of the test surface itself, as will be explained in detail below. The plane waves with parallel directions of propagation offset from one another can also be referred to as sheared plane waves. The offset is implemented in the lateral direction, i.e., across the direction of propagation of the input wave. In this case, the extent of the offset is at least one wavelength of the input wave and advantageously at least a multiple of the wavelength of the input wave, i.e., at least approximately 0.5 μm and in particular at least approximately 10 μm in the case of a wavelength in the visible range. The wavefront adaptation module can be configured as a diffractive optical element, for instance as a CGH or as a lens element, in particular as an aspherical lens element.

By generating the two measurement waves using the sheared plane waves, these measurement waves fulfilling the function of a test wave and a reference wave, propagate through the cavity between the wavefront adaptation module and the test surface along virtually the same beam path. Hence, possible air schlieren in the cavity have essentially the same influence on the two measurement waves, whereby the interferogram is modified only slightly, if at all. Thus, the configuration according to the disclosed techniques allows the measuring apparatus to be operated under normal pressure or under ambient pressure that has been reduced only slightly, for instance in coarse vacuum or fine vacuum. In any case, operation in high vacuum can be avoided, whereby the outlay for operating the measuring apparatus is reduced. According to an embodiment, a laminar, homogenous, uniform and stationary flow through the cavity, suitable at normal pressure, can also implemented via a specifically designed flow box. Unwanted effects resulting from such a reproducible laminar flow might possibly be eliminated almost entirely using a calibration in relation to a so-called “golden mirror.”

Further, defects or deviations in the wavefront adaptation module have virtually the same effect on the sheared plane waves in the configuration of the measuring apparatus according to the disclosed techniques. Thus, possible grating structure defects (should the wavefront adaptation module be configured as a diffractive optical element) or possible lens element defects (should the wavefront adaptation module be configured as an aspherical lens element) have virtually the same effect on both measurement waves. It is therefore possible to largely manage without complicated calibration methods for the wavefront adaptation module.

The generation of parallel plane waves according to the disclosed techniques by the splitting module (i.e., wave splitter) is advantageous in that the two measurement waves are exactly or substantially identical copies of one another apart from a lateral offset, i.e., both measurement waves exactly or substantially the same wavefront adapted to the surface to be measured. The only difference between the two measurement waves may be the fact that, in the event of a decomposition of the measurement waves into local waves and a labelling of the origin in the light source, the local waves with the same origin in the light source or with identical coherence are laterally offset in the two measurement waves.

The two measurement waves thus propagate back on themselves exactly in autocollimation, and hence the measurement waves meet one another with pinpoint accuracy on the detector even if the (ideal or nominal) shape of the test surface deviates significantly from the shape of a plane plate. Hence, measurement artifacts are avoided very reliably, and a high measurement accuracy can be obtained for objects under test with any desired surface shape, especially with a surface shape with a significant deviation from a plane face. Hence, the methodology may ensure that, in the idealized case, the two measurement waves propagate back exactly on themselves and interfere on the detector in ideal fashion since the waves arrive at the detector at identical points or almost identical points.

By contrast, radiating waves, especially plane waves or else expanding waves, with non-parallel directions of propagation at the wavefront adaptation module and/or using measurement waves with non-parallel directions of propagation would not lead to an exact autocollimation of the measurement waves, and would in turn entail increased measurement artifacts.

Furthermore, the wavefront adaptation module can be qualified vis-à-vis a plane mirror, for example in relation to material inhomogeneities of the wavefront adaptation module, i.e., a plane mirror is arranged in place of the object under test during the qualification, which is also referred to as calibration.

According to various embodiments, the splitting module (i.e., wave splitter) can be configured to generate more than two plane waves from the input wave, for example at least three or at least five plane waves with parallel directions of propagation and with a transverse offset from one another. In this case, the wavefront adaptation module can be configured to generate more than two measurement waves, for example at least three or at least five measurement waves, by adapting the respective wavefront of the plane waves with an offset from one another to a target shape of the optical test surface. According to various further embodiments, the measuring apparatus can also comprise more than one splitting module, for example at least two, at least three or at least five splitting modules, each of which are configured to generate, from the input wave, at least two plane waves with parallel directions of propagation and with an offset from one another across the directions of propagation. According to various further embodiments, the measuring apparatus can also comprise more than one wavefront adaptation module, for example at least two, at least three or at least five wavefront adaptation modules, for the purpose of generating at least two, at least three or at least five measurement waves in each case by adapting the respective wavefront of the plane waves with an offset from one another to a target shape of the optical test surface.

According to an embodiment, the measuring apparatus is configured such that the measurement waves, following their interaction with the test surface and prior to the incidence on the detector, pass through the splitting module in the opposite direction to the radiation of the input wave, and the measurement waves are offset toward one another in the process. In this context, “offset toward one another” should be understood to mean that the measurement waves are closer to one another after the offset than before. In particular, the offset is implemented in such a way that the measurement waves lie exactly on one another.

According to a further embodiment, the measuring apparatus comprises an evaluation device configured to ascertain at least a derivative of the shape of the test surface using the at least one captured interferogram.

According to a further embodiment, the measuring apparatus is configured to vary a splitting direction of the two plane waves. For example, this can be implemented by rotating the splitting module. Advantageously, the derivatives of the test surface are determined in different directions therefrom.

According to a further embodiment, the measuring apparatus is configured to vary a lateral offset of the two plane waves and hence vary the size of the derivative differential or the spatial resolution. It is possible to modify both directions of the derivatives and the size of the derivative differentials, and hence the spatial resolution, with the condition of reflection of the measurement waves in autocollimation at the mirror always being satisfied.

According to a further embodiment, the evaluation device is configured to ascertain derivatives of the shape of the test surface at a plurality of locations on the test surface and determine the shape of the test surface by integrating the ascertained derivatives. Advantageously, the integration makes use of derivatives in different directions at the individual locations on the test surface. The splitting direction is understood to mean the direction in which the directions of propagation of the two measurement waves are offset from one another.

In addition, measurements with different sizes of the splitting differences can also be utilized by different sizes of the beam offset and can additionally be used in the combination by calculation. In addition to giving consideration to derivatives in different directions, it is also advantageous to include the derivative directions that are rotated through 180°, and hence the derivative differences with opposite sign, so that both the left-hand and right-hand derivatives in a specific direction are captured at the surface.

According to a further embodiment, the splitting module comprises at least one beam direction splitting element (i.e., a beam direction splitter). The splitting module may also include additional beam direction splitting elements, such as two, three, four five, or more beam direction spitting elements according to various embodiment variants, The splitting module also includes at least one direction matching element (i.e., a direction matcher). The splitting module may also include additional direction matching elements, such as two, three, four five, or more direction matching elements according to various embodiment variants. The at least one beam direction splitting element may be configured to generate at least two intermediate waves, at least three or at least five intermediate waves according to different embodiment variants, with different directions of propagation from the input wave and the direction matching element being configured to generate the at least two mutually offset plane waves by matching the directions of propagation of the at least two intermediate waves to one another.

According to an embodiment variant, the distance between the beam direction splitting element and the direction matching element is of the order of the distance between the wavefront adaptation module and the test surface. The same applies to the distance between the direction matching element and the wavefront adaptation module. The spatial resolution can be set by the choice of distance between the beam direction splitting element and the direction matching element. On the one hand, varying the distance between the beam direction splitting element and the direction matching element can bring about a variation in the offset of the measurement waves, and hence a variation in the size of the derivative differentials and hence a variation in the spatial resolution. On the other hand, the distance variation can be used at the same time for phase shifting, with the distance variation typically being smaller than in the event of setting the spatial resolution.

According to a further embodiment, the beam direction splitting element and/or the direction matching element is configured as a diffractive optical element, especially as a CGH. To prevent reflections, the CGHs are tilted relative to one another according to an embodiment variant.

According to a further embodiment, the beam direction splitting element and/or the direction matching element is respectively configured to diffract incoming radiation only into the zeroth order of diffraction and, in terms of absolute value, first order of diffraction, for example into the 0th and +1st order of diffraction.

According to a further embodiment, the beam direction splitting element and/or the direction matching element are respectively configured to diffract incoming radiation only into the +1st and −1st order of diffraction.

According to a further embodiment, the beam direction splitting element and the direction matching element are diffractive optical elements with an inverted configuration to one another.

According to a further embodiment, the beam direction splitting element and/or the direction matching element is configured as a shearing prism. In this embodiment, the shearing prism may be, for example, a Nomarski prism, a Wollaston prism or a Rochon prism, among others.

According to a further embodiment, the measuring apparatus furthermore comprises a variable phase retardation element (also referred to as phase retarder) for phase shifting purposes. For example, the latter may contain a liquid crystal. The phase retardation element brings about different phase retardations for wavefronts of different polarization, and so, depending on the arrangement of the phase retardation element in the beam path, this brings about different phase retardations for the two intermediate waves for the two measurement waves.

According to a further embodiment, the direction matching element is configured as a shearing prism which is arranged with reversed orientation vis-à-vis a shearing prism of the same type serving as the beam direction splitting element.

According to a further embodiment, the beam direction splitting element is configured to split off the second intermediate wave from the input wave, with the first intermediate wave being a portion of the input wave passing through the beam direction splitting element without deflection. To this end, the beam direction splitting element can be configured as a Rochon prism or as a CGH, for example.

According to a further embodiment, the directions of propagation of the intermediate waves are oriented symmetrically with respect to the direction of propagation of the input wave.

According to a further embodiment, the measuring apparatus is configured to modify a distance between the beam direction splitting element and the direction matching element. Modifying the distance can serve to modify the relative phase angle between the two plane waves with an offset from one another. This serves what is known as phase shifting. In diffractive optical elements, especially CGHs, phase shifting is also possible by way of a lateral displacement of the diffractive optical element. Thus, when the beam direction splitting element and the direction matching element are each embodied as a diffractive optical element, phase shifting is also realizable by a lateral displacement of either the beam direction splitting element or the direction matching element. Modifying the distance between the beam direction splitting element and the direction matching element can also serve the purpose of varying the size of the derivative differentials and hence the spatial resolution.

The embodiment of the beam direction splitting element and/or direction matching element in the form of a CGH is advantageous in that additional diffractive auxiliary structures (e.g., cat eye or the Littrow structures) may be present on the CGH, and these are advantageous for the adjustment of the two elements of the splitting module relative to one another or relative to the interferometer (the entire optical unit upstream of the splitting module, i.e., the illumination and imaging unit) and also for the adjustment of the wavefront adaptation module vis-à-vis the splitting module or the entire interferometer.

According to a further embodiment, the splitting module comprises a shearing plate. The latter preferably has parallel sides but may also be embodied in the form of a wedge. In any case, the shearing plate is configured such that a first output wave is generated from the light of the input wave, and this first output wave leaves the shearing plate at the exit side opposite the entrance side without further reflections; the second output wave is generated from the light of the input wave which is initially reflected back and forth at the exit side and entrance side of the shearing plate prior to its exit on the exit side. For example, phase shifting can be implemented by tilting the shearing plate. Tilting the shearing plate leads to a modification of the path length difference of the two beams in the plate.

According to a further embodiment, the measuring apparatus is configured to measure a mirror for EUV microlithography as the object under test, such as a mirror of an illumination system or of a projection lens of an EUV projection exposure apparatus.

Furthermore, the aforementioned object can be achieved, for example, by a method for interferometric determination of a property of a shape of a test surface of an object under test. The method comprises a generation of two plane waves with two parallel directions of propagation, which are offset from one another across the directions of propagation, by splitting an input wave. Furthermore, two measurement waves are generated from the plane waves by adapting the respective wavefront of the plane waves with an offset from one another to a target shape of the optical test surface, and at least one interferogram is generated by superposition of the measurement waves following their interaction with the test surface and capturing the interferogram.

The features specified with respect to the aforementioned embodiments, exemplary embodiments or embodiment variants, etc., of the measuring apparatus according to the disclosed techniques can be correspondingly applied to the method according to the disclosed techniques, and vice versa. These and other features of the embodiments according to the disclosed techniques will be explained in the description of the figures and in the claims. The individual features can be implemented, either separately or in combination, as embodiments of the disclosed techniques.

Furthermore, they can describe advantageous embodiments which are independently protectable and protection for which is claimed only during or after pendency of the application, as the case may be.

### BRIEF DESCRIPTION OF THE DRAWINGS

The aforementioned features and further advantageous features of the disclosed techniques will be illustrated in the following detailed description of exemplary embodiments according to the disclosed techniques or of embodiments or embodiment variants with reference to the attached schematic drawings, in which:

FIG. 1 shows an exemplary embodiment of a measuring apparatus for interferometric determination of the shape of a test surface of an object under test, having a splitting module made of two diffractive optical elements for generating two parallel plane waves and a wavefront adaptation module for generating two measurement waves from the plane waves;

FIG. 2 shows an exemplary embodiment of an arrangement for qualifying or calibrating the wavefront adaptation module according to FIG. 1;

FIG. 3 shows an exemplary embodiment of an arrangement for qualifying or calibrating the interferometer including the splitting module of the measuring apparatus according to FIG. 1;

FIG. 4 shows a further exemplary embodiment of a measuring apparatus for interferometric determination of the shape of a test surface of an object under test, having diffractive optical elements of the splitting module with a different design to those in FIG. 1;

FIG. 5 shows a further exemplary embodiment of a measuring apparatus for interferometric determination of the shape of a test surface of an object under test, wherein the diffractive optical elements of the splitting module have a tilted arrangement;

FIG. 6 shows a further exemplary embodiment of a measuring apparatus for interferometric determination of the shape of a test surface of an object under test, wherein one of the two diffractive optical elements of the splitting module is formed by a shearing prism;

FIG. 7 shows a further exemplary embodiment of a measuring apparatus for interferometric determination of the shape of a test surface of an object under test, wherein both diffractive optical elements of the splitting module are formed by shearing prisms;

FIG. 8 shows a further exemplary embodiment of a measuring apparatus for interferometric determination of the shape of a test surface of an object under test, wherein one of the two diffractive optical elements of the splitting module is configured as a Rochon prism;

FIG. 9 shows a further exemplary embodiment of a measuring apparatus for interferometric determination of the shape of a test surface of an object under test, wherein the splitting module is formed by a shearing plate; and

FIG. 10 shows a further exemplary embodiment of a measuring apparatus for interferometric determination of the shape of a test surface of an object under test, wherein the wavefront adaptation module is formed by a lens element.

### DETAILED DESCRIPTION

In the exemplary embodiments, embodiments or embodiment variants described below, elements which are functionally or structurally similar to one another are provided with the same or similar reference numerals, if possible. Therefore, for understanding the features of the individual elements of a specific exemplary embodiment, reference should be made to the description of other exemplary embodiments or the general description of the disclosed techniques.

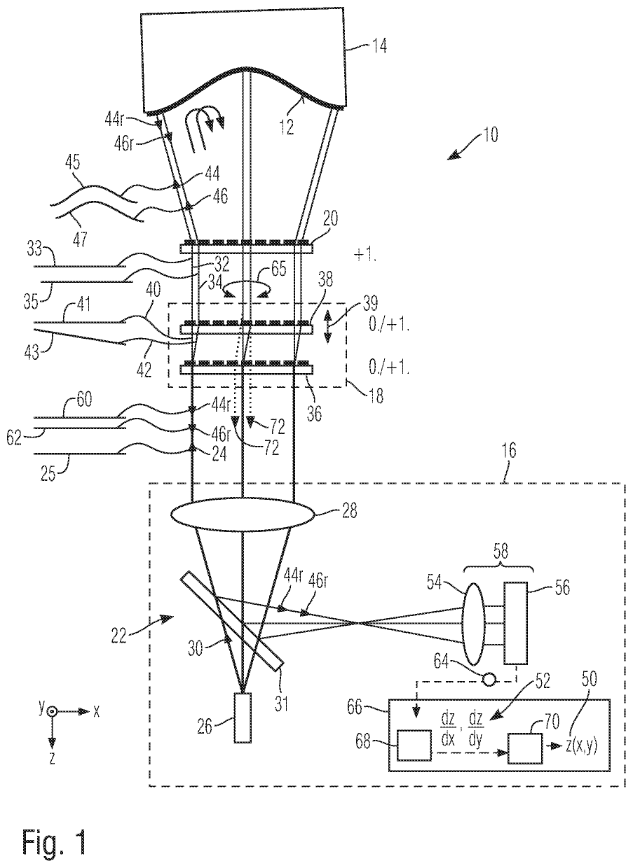

In order to facilitate the description, a Cartesian xyz-coordinate system is indicated in the drawing, from which the respective positional relationships of the components illustrated in the figures is evident. In FIG. 1, the y-direction runs out of the plane of the drawing in perpendicular fashion, the x-direction runs towards the right, and the z-direction runs downwards.

FIG. 1 schematically depicts an exemplary embodiment 10 of a measuring apparatus for interferometric determination of a property of a shape z(x,y) (reference numeral 50) of a test surface 12 of an object under test 14. The determined property can be one or more derivatives dz/dx and/or dz/dy (reference numeral 52) of the shape z(x,y) of the test surface 12 or else the shape 50 of the test surface 12 itself. The shape of the test surface 12 or, in particular, a target shape of the test surface 12 might be non-spherical. In particular, the shape may be designed as an aspherical surface or as a free-form surface. An aspherical surface is understood to be a rotationally symmetric surface which deviates from any sphere by at least 0.05 mm. In specific examples, the deviation from any sphere may be by at least 0.1 mm, by at least 1 mm or by at least 5 mm. In this disclosure, such an aspherical surface is also referred to as a rotationally symmetric asphere or simply as an asphere. A free-form surface is understood to be a shape with a deviation from any rotationally symmetric asphere of least 5 μm. In specific examples the free-form shape may deviate from any rotationally symmetric asphere by at least 10 μm. Furthermore, the free-form surface may deviate from any sphere by at least 0.05 mm, by at least 0.1 mm, by at least 1 mm or by at least 5 mm.

The measuring apparatus 10 is suitable, in particular, for very precise measurement of the optical surface of an aspherical mirror or of a free-form mirror for microlithography with an exposure radiation in the extreme ultraviolet (EUV) spectral range. The EUV wavelength range extends to wavelengths below 100 nm and relates, in particular, to wavelengths of approximately 13.5 nm or approximately 6.8 nm. To reduce aberrations or correct aberrations, such optical surfaces require a shape determination down into the subnanometer range. However, the measuring apparatus 10 is also suitable for measuring the surface of many other objects.

The measuring apparatus 10 comprises a beam generation and evaluation device 16, a splitting module 18 and a wavefront adaptation module configured as a diffractive optical element 20. The beam generation and evaluation device 16 comprises an irradiation device 22 which serves to generate an input wave 24 and comprises a radiation source 26 and a collimator lens element 28.

The radiation source 26 generates a measurement radiation 30, sufficiently coherent for interference, in the form of an expanding wave. According to an exemplary embodiment, the radiation source 26 is a helium-neon laser with a wavelength of approximately 633 nm. The measurement radiation 30 may also have a different wavelength in the visible or non-visible wavelength range of electromagnetic radiation. The measurement radiation 30 generated by the radiation source 26 passes initially through a beam splitter 31 and then through the collimator lens element 28.

The input wave 24 generated by the irradiation device 22 is a plane wave, i.e., it has a plane wavefront 25. The input wave 24 is incident on the splitting module 18, which is configured to split the input wave 24 into two plane waves 32 and 34, i.e., waves with plane wavefronts 33 and 35, respectively, with parallel directions of propagation. In other words, the beam paths of the plane waves 32 and 34 are offset from one another across their propagation direction in a splitting direction. In the exemplary embodiment according to FIG. 1, the split is implemented by splitting off the plane wave 34 from the input wave 24, while the plane wave 32 is formed from the remaining radiation portion of the input wave 24. The splitting direction depicted in FIG. 1 is the x-direction.

In the exemplary embodiment according to FIG. 1, the splitting module 18 comprises a beam direction splitting element in the form of a diffractive optical element 36 designed as a CGH and a direction matching element likewise in the form of a diffractive optical element 38 designed as a CGH. The beam direction splitting element is configured to generate, from the input wave 24, two intermediate waves 40 and 42 with different propagation directions. The intermediate waves 40 and 42 have plane wave fronts 41 and 43 that are tilted to one another. In the exemplary embodiment according to FIG. 1, the intermediate waves 40 and 42 are generated by splitting off the intermediate wave 42 with a slightly tilted direction of propagation from the input wave 24, while the intermediate wave 40 is formed from the remaining radiation portion of the input wave 24. To this end, the diffractive optical element 36 is configured to generate in transmission a 0th and a 1st order of diffraction of the input wave 24, with the 0th order of diffraction acting as the intermediate wave 40 and the 1st order of diffraction acting as the intermediate wave 42.

The direction matching element 38 is configured to match the directions of propagation of the two intermediate waves 40 and 42 to one another, thus generating the two plane waves 32 and 34 which are offset from one another. In the exemplary embodiment according to FIG. 1, this is implemented by slightly deflecting the intermediate wave 24, to be precise, in such a way that the latter, now in the form of the plane wave 32, receives the same direction of propagation as the intermediate wave 40. To this end, the diffractive optical element 38 is configured to generate in transmission in each case a 0th and a 1st order of diffraction of the intermediate waves 40 and 42, with the 0th order of diffraction of the intermediate wave 40 acting as the plane wave 32 and the 1st order of diffraction of the intermediate wave 42 acting as the plane wave 34. In other words, the two diffractive optical elements 36 and 38 have an inverted configuration to one another.

The wavefront adaptation module in the form of the diffractive optical element 20 designed as a CGH, for example, is configured to adapt the respective wavefront of the plane waves 32 and 34 to a target shape of the test surface 12 by diffraction into the 1st order of diffraction, and hence for example, generate two measurement waves 44 and 46, each with non-spherical wavefronts 45 and 47. As a result of adapting the wavefronts 45 and 47 to the target shape, the measurement waves 44 and 46 would be incident in perpendicular fashion at each location on the test surface 12 and would be precisely reflected back onto themselves if the test surface were to correspond exactly to the target shape. Deviations from the target shape lead to an interference pattern, which allows the real surface shape to be determined very accurately, in the superposition, described in more detail below, of the reflected measurement waves 44r and 46r, i.e., of the measurement waves 44 and 46 following their interaction with the test surface 12.

The reflected measurement waves 44r and 46r pass through the diffractive optical element 20 that acts as a wavefront adaptation module, and in so doing, are converted back into mutually offset waves running in parallel which differ from the plane waves 32 and 34 merely by deviations caused by the deviation of the test surface 12 from its target shape. Thereupon, the reflected measurement waves 44r and 46r run in the beam paths of the intermediate waves 40 and 42 and of the input wave 24, albeit in the opposite direction to that of the radiation of the input wave 24. When passing through the splitting module 18 in the reverse direction, the measurement waves 44r and 46r are offset toward one another, to be precise, in such a way that the measurement waves 44r and 46r are located exactly on one another.

The wave generated in the 0th order of diffraction of the measurement wave 44r when the latter passes through the diffractive optical element 38 is still referred to as measurement wave 44r over the further course of the beam path, while the 1st order of diffraction of the measurement wave 44r represents a non-utilized surplus wave 72. Analogously, the wave generated in the 1st order of diffraction of the measurement wave 46r when the latter passes through the diffractive optical element 38 is still referred to as measurement wave 46r over the further course of the beam path, while the 0th order of diffraction of the measurement wave 46r likewise represents a non-utilized surplus wave 72. Analogously, non-utilized surplus waves 72 are generated at the diffractive optical element 36.

Such surplus waves can also arise on the outward leg when the input wave 24 passes through the diffractive optical element 36 and the diffractive optical element 38. According to an embodiment, the diffractive optical elements 36 and 38 can be embodied as blazed gratings such that the unwanted orders of diffraction are substantially suppressed in terms of their efficiencies.

Hence, following the passage through the splitting module 18 in reverse, the reflected measurement waves 44r and 46r run along the same beam path, i.e., they are no longer offset from one another, and have wavefronts 60 and 62 that differ from plane wavefronts only by the deviations caused by the deviation of the test surface 12 from its target shape. Since the measurement waves 44 and 46 are incident on the test surface 12 with a slight offset from one another, these deviations of the test surface 12 become noticeable by way of phase deviations in the wavefronts 60 and 62.

In the beam generation and evaluation device 16, the reflected measurement waves 44r and 46r are deflected in the direction of a camera 58 by the beam splitter 31 following their passage through the collimator lens element 28. Both reflected measurement waves 44r and 46r pass through an eyepiece 54 and are incident on a detector 56 of the camera 58. The detector 56 comprises a CCD sensor, for example, and captures a plurality of interferograms 64 generated by the superposition of the reflected measurement waves 44r and 46r. The aforementioned surplus waves 72 have such a beam path that the radiation thereof does not contribute, or only contributes insubstantially, to the interferograms 64 as these surplus waves are no longer incident on the camera 58 at the same locations as the used waves, and hence the condition for constructive interference is no longer satisfied. The local surplus waves and the local used waves for the same source point arrive at the camera at different locations or—expressed the other way around—the surplus waves and the used waves at one point on the camera 58 are no longer completely coherent with one another as they originate from different source locations.

The captured interferograms 64 are generated by modifying the relative phase angle between the two mutually offset plane waves 32 and 34 or the two measurement waves 44 and 46. This modification of the relative phase angle is known as phase shifting. In the embodiment according to FIG. 1, this is implemented by modifying the distance between the diffractive optical element 38 serving as a direction matching element and the diffractive optical element 36 serving as a beam direction splitting element. In this case, the distance is modified by an axial displacement of the diffractive optical element 38. A displacement device illustrated by a double-headed arrow 39 is provided to this end. Alternatively, the diffractive optical element 36 can also be displaced axially. According to other embodiments, phase shifting can also be implemented by varying the wavelength λ of the measurement radiation 30 or by other measures. Phase shifting can also be implemented by way of a lateral displacement of the beam direction splitting element designed as diffractive optical element 36 or of the direction matching element designed as diffractive optical element 38.

Furthermore, the measuring apparatus 10 is configured to vary the splitting direction of the two plane waves 32 and 34. To this end, the splitting module 18 in the embodiment according to FIG. 1 is rotatably mounted in the axial direction, i.e., in relation to the incoming radiation direction of the input wave 24. According to an embodiment variant, the splitting module 18 is rotated through 90° following the capture of the interferograms 64 (also referred to as first set of interferograms below) in the position shown in FIG. 1, in which the splitting direction is oriented in the x-direction. A turning device 65 illustrated by a double-headed arrow is provided to this end. This arranges the splitting direction in the y-direction. A second set of interferograms 64 is ascertained with appropriate phase shifting in this arrangement.

Both sets of captured interferograms 64 are transmitted to an evaluation device 66 which comprises a first evaluation module 68 and a second evaluation module 70. Derivatives dz/dx and dz/dy (reference sign 52) of the shape 50 of the test surface 12 are determined in the first evaluation module 68 from the interferograms 64. In this case, the first set of interferograms 64, which were ascertained for the split in the x-direction, serve to determine the derivatives dz/dx and the second set of interferograms 64, which were ascertained for the split in the y-direction, serve to determine the derivatives dz/dy.

The derivatives 52 are ascertained at the various coordinate points (x,y) of the test surface 12, i.e., at a plurality of locations on the test surface 12. The shape 50 of the test surface 12 is determined in the second evaluation module 70 by integrating the ascertained derivatives dz/dx and dz/dy. The measuring apparatus 10 is operated in air under normal pressure. This is possible since the interfering waves, specifically the measurement waves 44r and 46r, pass over almost the same beam path, and thus air turbulence or air pressure variations have hardly any influence on the measurement accuracy of the measuring apparatus 10. It is thus possible to make do without an arrangement of the measuring apparatus 10 in vacuo, in particular in a high vacuum.

The size of the beam split between the intermediate waves 40 and 42, and hence the spatial resolution of the shape measurement, can be varied by changing the distance between the diffractive optical elements 36 and 38.

A further advantage of the measuring apparatus 10 according to FIG. 1 lies in the fact that the test surface 12 to be examined also serves as a reference surface at the same time, and so no additional optical element is required as a reference mirror. This removes the outlay for the production and examination of such a reference mirror. This also removes possible influences of errors on the measurement. In the testing of optical units utilizing a reference or Fizeau element, the test and reference wave take very different light paths and thus also experience errors of different magnitudes. Furthermore, the use of the test surface 12 as a reference surface enables a contrast of similar size, independently of the reflectivity of the testing mirror.

A further advantage of the measuring apparatus 10 according to FIG. 1 lies in the fact that the contrast is virtually independent of the reflectivity of a measured mirror, in particular virtually independent of whether or not the mirror is coated.

A further advantage of the measuring apparatus 10 according to FIG. 1 lies in the fact that, in particular, an incoherent light source can also be used in addition to a coherent light source, with the advantage that bothersome reflections in the interferogram are subject to significant suppression.

It should also be mentioned that if a wavefront adaptation module 20 is designed as a diffractive optical element or CGH, then this wavefront adaptation module is a diffractive optical element with only one encoded functionality, and that the test and reference waves see this module virtually the same, with the result that this diffractive optical element normally has fewer production errors. It is thus possible to implement such a wavefront adaptation module without a special additional external qualification and without a special calibration measurement of the module to be performed with additional mirrors in the test setup.

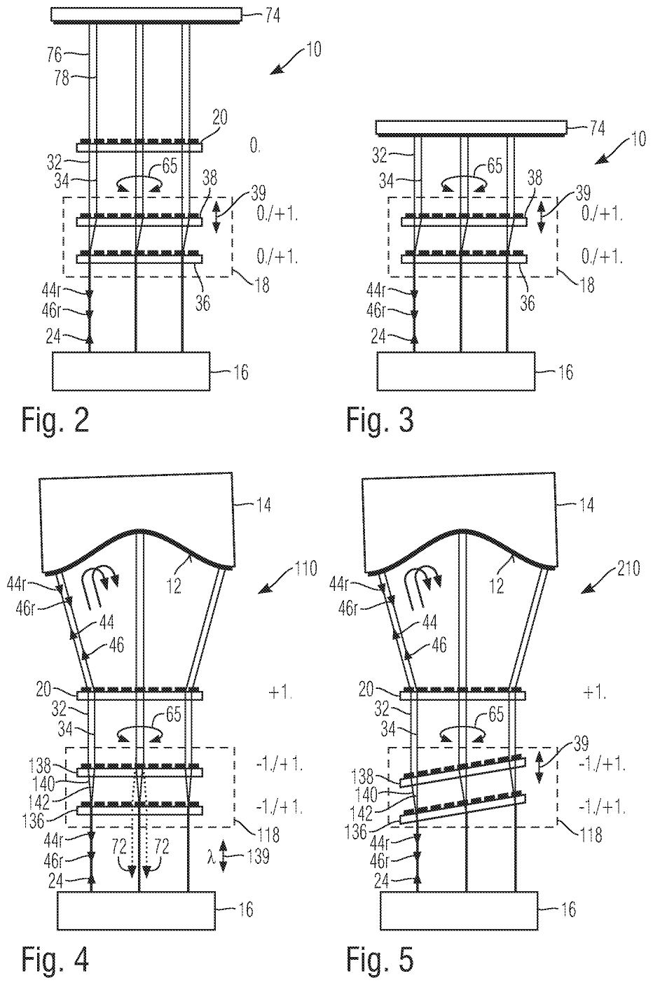

FIG. 2 illustrates a qualification or calibration of the diffractive optical element 20 acting as a wavefront adaptation module. To this end, a plane calibration mirror 74 is arranged in place of the object under test 14. The interferograms arising on the detector 56 by the superposition of the plane waves 32 and 34, referred to here as calibration waves 76 and 78, passing through the diffractive optical element 20 in the 0th order of diffraction, are evaluated. From this, it is possible to determine, for example, material inhomogeneities in the substrate of the diffractive optical element 20.

FIG. 3 illustrates a qualification or calibration of the interferometer including the splitting module 18. To this end, the plane calibration mirror 74 is arranged in place of the diffractive optical element 20. The interferograms arising on the detector 16 by the superposition of the plane waves 32 and 34 reflected at the calibration mirror 74 are evaluated. From this, it is possible to determine, for example, material inhomogeneities in the substrates of the diffractive optical elements 36 and 38 or other deviations in the beam path of the interferometer. Taking account of the qualification according to FIG. 3, the qualification according to FIG. 2 can be used to separate the influence of the error of the wavefront adaptation module from virtually all other error contributions in the interferogram.

FIG. 4 schematically depicts a further exemplary embodiment 110 of a measuring apparatus for interferometric determination of a property of a shape of a test surface 12 of an object under test 14. The measuring apparatus 110 differs from the measuring apparatus 10 according to FIG. 1 only in the configuration of the splitting module 18, which is denoted by reference numeral 118 in FIG. 4, and in the method of phase shifting. The beam generation and evaluation device 16 is only depicted schematically in FIG. 4.

The splitting module 118 also comprises diffractive optical elements configured as beam direction splitting element and direction matching element, which are denoted by the reference numerals 136 and 138, respectively. The diffractive optical elements 136 and 138 according to FIG. 4 differ from the diffractive optical elements 36 and 38 to the effect of being configured to be operated in the 1st order of diffraction rather than in the 0th/1st order of diffraction. That is to say, intermediate waves 140 and 142 are generated in transmission at the diffractive optical element 136 in the −1st and +1st order of diffraction of the input wave 24. As a result, the directions of propagation of the intermediate waves 140 and 142 are oriented symmetrically with respect to the direction of propagation of the input wave 24. Furthermore, the 1st order of diffraction of the intermediate wave 140 then serves as plane wave 32, and the 1st order of diffraction of the intermediate wave 142 serves as plane wave 34.

FIG. 5 schematically depicts a further exemplary embodiment 210 of a measuring apparatus for interferometric determination of a property of a shape of a test surface 12 of an object under test 14. The measuring apparatus 210 differs from the measuring apparatus 110 according to FIG. 4 only in that the diffractive optical elements 136 and 138 are tilted vis-à-vis the perpendicular arrangement with respect to the beam direction of the input wave 24. The tilt of diffractive optical elements 136 and 138 may be at least 1°, and in particular, at least 10°. The tilt can bring about phase shifting, like in the embodiment according to FIG. 1, by displacing the diffractive optical element 138 serving as a direction matching element. A displacement device illustrated by a double-headed arrow 39 is provided in the measuring apparatus 210 to this end.

A further important advantage of this tilted version of the splitting module lies in the suppression of the reflection light for the reflection at the unstructured surfaces of the beam direction splitting element and of the direction matching element in the non-tilted case, in the event of which the reflection light runs back on itself in the direction of the input wave 24.

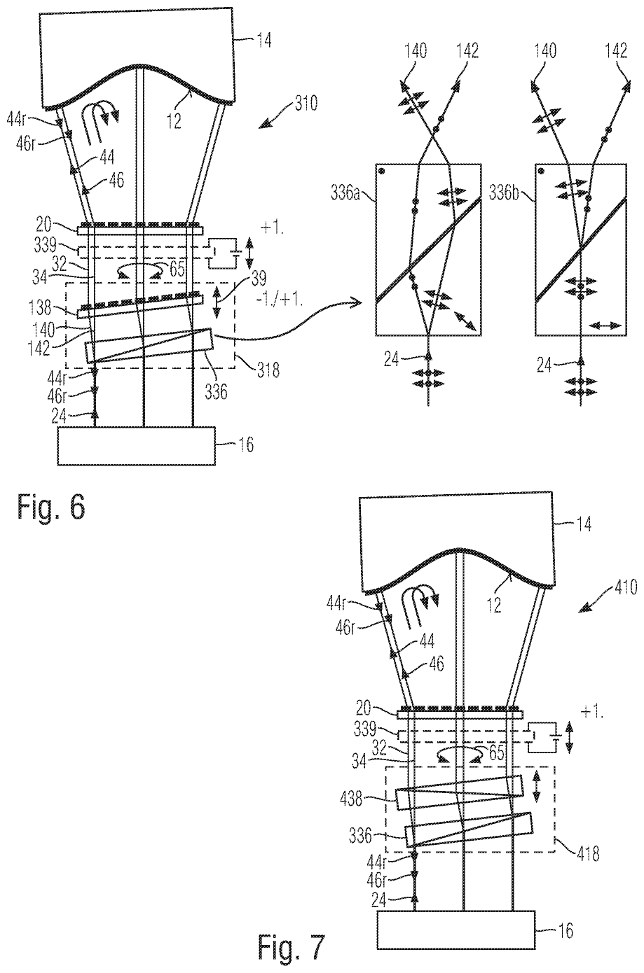

FIG. 6 schematically depicts a further exemplary embodiment 310 of a measuring apparatus for interferometric determination of a property of a shape of a test surface 12 of an object under test 14. The measuring apparatus 310 differs from the measuring apparatus 210 according to FIG. 5 only in that the element serving as a beam splitting element is formed not by the diffractive optical element 136 but by a shearing prism 336. The shearing prism 336 is configured to split the input wave 24, which comprises unpolarized or diagonally polarized light in this exemplary embodiment, into two beams which are tilted relative to one another and have differently polarized light, which then serve as the intermediate waves 140 and 142.

Exemplary embodiments for the shearing prism 336 can be designed as a Nomarski prism 336a or as Wollaston prism 336b. As illustrated in FIG. 6, the unpolarized or diagonally polarized input wave 24 is separated into two beams with linear polarizations at right angles to one another, which are deflected in different directions in relation to the input wave 24 and which serve as intermediate waves 140 and 142, in the case of both the Nomarski prism 336a and the Wollaston prism 336b. In this case, the intermediate waves 140 can be oriented symmetrically with respect to the direction of propagation of the input wave 24.

Like in the measuring apparatus 210 according to FIG. 5, phase shifting in the measuring apparatus 310 can be implemented by an axial displacement of the diffractive optical element 138 serving as a direction matching element. Furthermore, phase shifting can also implemented by a lateral displacement of the shearing prism 336.

Alternatively, a variable phase retardation element 339 can serve for phase shifting purposes. Said variable phase retardation element 339 can be arranged between the diffractive optical element 118 of the splitting module 318 and the diffractive optical element 20 serving as wavefront adaptation module 20. The variable phase retardation element 339, also referred to as phase retarder, might contain a liquid crystal, for example, and brings about different phase retardations for wavefronts of different polarization. Hence this brings about different phase retardations for the two plane waves 32 and 34 or the two returning measurement waves 44r and 46r.

FIG. 7 schematically depicts a further exemplary embodiment 410 of a measuring apparatus for interferometric determination of a property of a shape of a test surface 12 of an object under test 14. The measuring apparatus 410 differs from the measuring apparatus 310 according to FIG. 6 only in that the direction matching element is also formed by a shearing prism 438. In the splitting module 418 resulting therefrom, the functionality of the sharing prism 438 corresponds to that of the shearing prism 336 in the opposite direction. That is to say, vis-à-vis the shearing prism 336 of the same type, the shearing prism 438 is arranged in an opposite orientation. According to an exemplary embodiment not depicted in the drawing, the splitting module 18 might also comprise a diffractive optical element as beam direction splitting element and a shearing prism as direction matching element.

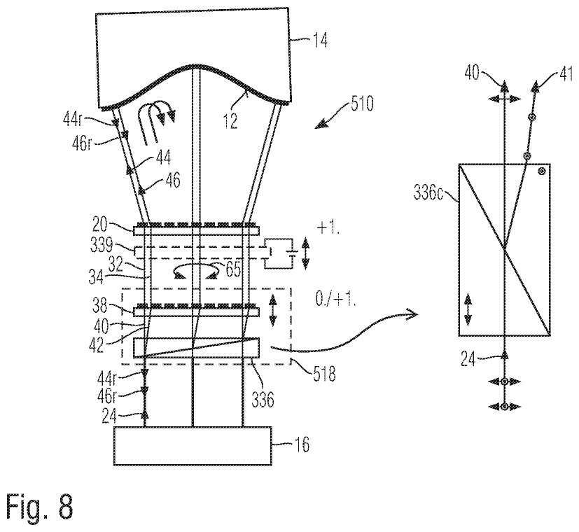

FIG. 8 schematically depicts a further exemplary embodiment 510 of a measuring apparatus for interferometric determination of a property of a shape of a test surface 12 of an object under test 14. The measuring apparatus 510 differs from the measuring apparatus 310 according to FIG. 6 only in that the shearing prism 336 serves as a beam direction splitting element that is configured not as a Nomarski prism or a Wollaston prism but as Rochon prism 336c. Unlike the embodiment according to FIG. 6, in which the intermediate waves 140 and 142 formed by the shearing prism 336 are oriented symmetrically with respect to the direction of propagation of the input wave 24, the intermediate wave 40 in the measuring apparatus 510 according to FIG. 8 has the same direction of propagation as the input wave 24 on account of using the Rochon prism 336c, while the intermediate wave 42 is tilted vis-à-vis the input wave 24.

The beam guidance in the resultant splitting module 518 thus substantially corresponds to the beam guidance also present in the embodiment 10 according to FIG. 1. Hence, the diffractive optical element 38 according to FIG. 1 or a diffractive optical element with a similar configuration can be used as a direction matching element.

Alternatively, a Rochon prism with a reversed orientation can be used in place of the diffractive optical element 38 as a direction matching element. According to a further exemplary embodiment not depicted in the drawing, the diffractive optical element 36 is combined with a Rochon prism serving as a direction matching element.

As illustrated in FIG. 8, an unpolarized or diagonally polarized input wave 24 is converted into an ordinary beam (intermediate wave 40) passing through the prism without deflection and a deflected extraordinary beam (intermediate wave 42) in the case of the Rochon prism 336c. The two beams are polarized at right angles to one another. The size of the beam split and hence the spatial resolution of the shape measurement can be varied by displacing the two partial elements of the Rochon prism or by changing the distance between the Rochon prism, i.e., the shearing prism 336, and the diffractive optical element 38.

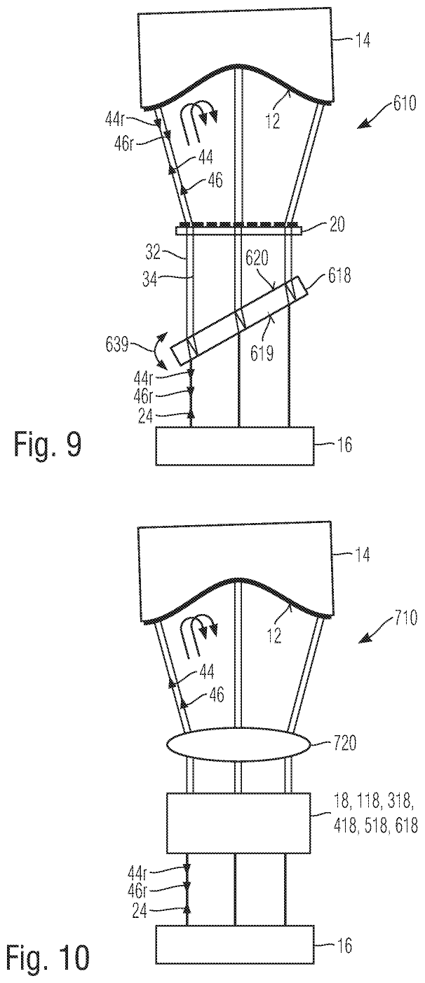

FIG. 9 schematically depicts a further exemplary embodiment 610 of a measuring apparatus for interferometric determination of a property of a shape of a test surface 12 of an object under test 14. The measuring apparatus 610 differs from the measuring apparatus 10 according to FIG. 1 only in that the splitting module is formed not by the two diffractive optical elements 36 and 38 but by a shearing plate 618.

The shearing plate 618 has parallel sides, i.e., it has the shape of a cuboid with parallel entrance and exit faces 619, 620 for the measurement radiation 30. The shearing plate is arranged at the tilt vis-à-vis the input wave 24, i.e., the normals of the entrance and exit faces 619, 620 are tilted vis-à-vis the direction of propagation of the input wave 24, to be precise by, advantageously, at least 1°, and in particular by at least 10° or 20°. Some of the radiation of the input wave 24 enters the shearing plate 618 at the face 619 and is split at the opposite face 620.

Some of the radiation incident at the face 620 directly leaves the shearing plate 618 again and forms the first plane wave 32. The remaining portion of the radiation is reflected at the face 620. On account of the tilt of the shearing plate 618, the reflected beam is tilted vis-à-vis the beam incident at the face 620. Some of the reflected radiation is reflected at the face 619 again, and then emerges at the face 620 as second plane wave 34. The latter is offset vis-à-vis the first plane wave 32.

Phase shifting can be implemented by tilting the shearing plate 618. To this end, the measuring apparatus 610 has a tilting apparatus 639. Other phase shifting options, for example varying the wavelength of the measurement radiation 30 as already described above, can likewise be applied here.

FIG. 10 schematically depicts a further exemplary embodiment 710 of a measuring apparatus for interferometric determination of a property of a shape of a test surface 12 of an object under test 14. The measuring apparatus 610 differs from the measuring apparatuses 10, 110, 210, 310, 410, 510 or 610 according to FIGS. 1, 4, 5, 6, 7, 8 and 9, respectively, only in that the wavefront adaptation module is configured not as a diffractive optical element but as a lens element 720, in particular as an aspherical lens element.

The above description of exemplary embodiments, embodiments or embodiment variants should be understood to be by way of example. The disclosure effected thereby firstly enables the person skilled in the art to understand the disclosed techniques and the advantages associated therewith, and secondly encompasses alterations and modifications of the described structures and methods that are also obvious in the understanding of the person skilled in the art. Therefore, all such alterations and modifications, insofar as they fall within the scope of the disclosed techniques in accordance with the definition in the accompanying claims, and equivalents are intended to be covered by the protection of the claims.

### LIST OF REFERENCE NUMERALS

10 Measuring apparatus
12 Test surface
14 Object under test
16 Beam generation and evaluation device
18 Splitting module
20 Diffractive optical element as a wavefront adaptation module
22 Irradiation device
24 Input wave
25 Plane wavefront
26 Radiation source
28 Collimator lens element
30 Measurement radiation
31 Beam splitter
32 First plane wave
33 Plane wavefront
34 Second plane wave
35 Plane wavefront
36 Diffractive optical element as a beam direction splitting element
38 Diffractive optical element as a direction matching element
39 Displacement device
40 First intermediate wave
41 Plane wavefront
42 Second intermediate wave
43 Plane wavefront
44 First measurement wave
44r Reflected first measurement wave
45 Wavefront of the first measurement wave
46 Second measurement wave
46r Reflected second measurement wave
47 Wavefront of the second measurement wave
50 Shape of the test surface
52 Derivatives of the shape of the test surface
54 Eyepiece
56 Detector
58 Camera
60 Wavefront of the first reflected measurement wave
62 Wavefront of the second reflected measurement wave
64 Interferogram
65 Turning device
66 Evaluation device
68 First evaluation module
70 Second evaluation module
72 Surplus wave
74 Plane calibration mirror
76 Calibration wave
78 Calibration wave
110 Measuring apparatus
118 Splitting module
136 Diffractive optical element as a beam direction splitting element
138 Diffractive optical element as a direction matching element
139 Wavelength manipulation device
210 Measuring apparatus
310 Measuring apparatus
318 Splitting module
336 Shearing prism
336a Nomarski prism
336b Wollaston prism
336c Rochon prism
339 Variable phase retardation element
410 Measuring apparatus
418 Splitting module
438 Shearing prism
510 Measuring apparatus
518 Splitting module
610 Measuring apparatus
618 Shearing plate
619 Entrance or exit face
620 Entrance or exit face
639 Tilting device
720 Lens as a wavefront adaptation module

What is claimed is:

1. An apparatus for interferometric determination of a property of a shape of a test surface of an object under test, comprising:
an irradiation source configured to generate an input wave,
a wave splitter configured to generate, from the input wave, two plane waves with parallel directions of propagation and with an offset from one another across the parallel directions of propagation,
a wavefront adaptor configured to generate two measurement waves by respectively adapting wavefronts of the two plane waves with an offset from one another to a target shape of the test surface, and
a detector configured to capture at least one interferogram generated by superposition of the two measurement waves following their interaction with the test surface.

2. The apparatus of claim 1,
configured such that the two measurement waves, following their interaction with the test surface and prior to incidence on the detector, pass through the wave splitter in a direction opposite to a direction radiation of the input wave passes through the wave splitter, and the two measurement waves are offset toward one another due to passing through the wave splitter.

3. The apparatus of claim 1,
comprising an evaluator configured to ascertain at least a derivative of the shape of the test surface using the at least one interferogram.

4. The apparatus of claim 3,
wherein the evaluator is configured to ascertain derivatives of the shape of the test surface at a plurality of locations on the test surface and determine the shape of the test surface by integrating the derivatives.

5. The apparatus of claim 1,
configured to vary a splitting direction of the two plane waves.

6. The apparatus of claim 1,
wherein the wave splitter comprises a beam direction splitter and a direction matcher, the beam direction splitter being configured to generate two intermediate waves with different directions of propagation from the input wave and the direction matcher being configured to generate the two plane waves by matching directions of propagation of the two intermediate waves to one another.

7. The apparatus of claim 6,
wherein the beam direction splitter and/or the direction matcher is configured as a diffractive optical element.

8. The apparatus of claim 7,
wherein the beam direction splitter and/or the direction matcher is respectively configured to diffract incoming radiation only into a zeroth order of diffraction and, in terms of absolute value, first order of diffraction.

9. The apparatus of claim 7,
wherein the beam direction splitter and/or the direction matcher are respectively configured to diffract incoming radiation only into +1st and −1st orders of diffraction.

10. The apparatus of claim 6,
wherein the beam direction splitter and the direction matcher are diffractive optical elements with an inverted configuration to one another.

11. The apparatus of claim 6,
wherein the beam direction splitter and/or the direction matcher is configured as a shearing prism.

12. The apparatus of claim 6,
wherein the direction matcher is configured as a shearing prism which is arranged with reversed orientation vis-à-vis a shearing prism of a same type serving as the beam direction splitter.

13. The apparatus of claim 6,
wherein the beam direction splitter is configured to split off a second intermediate wave of the two intermediate waves from the input wave, with a first intermediate wave of the two intermediate waves being a portion of the input wave passing through the beam direction splitter without deflection.

14. The apparatus of claim 6,
wherein directions of propagation of the two intermediate waves are oriented symmetrically with respect to a direction of propagation of the input wave.

15. The apparatus of claim 6,
configured to modify a distance between the beam direction splitter and the direction matcher.

16. The apparatus of claim 1,
wherein the wave splitter comprises a shearing plate.

17. The apparatus of claim 1,
configured to measure a mirror for EUV microlithography as object under test.

18. A method for interferometric determination of a property of a shape of a test surface of an object under test, comprising:
generating two plane waves with two parallel directions of propagation, which are offset from one another across the two parallel directions propagation, by splitting an input wave,
generating two measurement waves from the two plane waves by adapting respective wavefronts of the two plane waves with an offset from one another to a target shape of the test surface, and
generating at least one interferogram by superposition of the two measurement waves following their interaction with the test surface and capturing the at least one interferogram.
